(19) United States
(12) Patent Application Publication
(10) Pub. No.: US 2006/0232529 A1
(43) Pub. Date: Oct. 19, 2006

(54) Liquid crystal display device and production method thereof

(75) Inventor: Teruyuki Midorikawa, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/393,772

(22) Filed: Mar. 31, 2006

(30) Foreign Application Priority Data
Apr. 18, 2005 (JP) 2005-119717

(51) Int. Cl. G09G 3/36

(52) U.S. Cl. 345/87

(57) ABSTRACT

Each pixel of an array substrate is provided with a reflective region and a transmittance region. A first color filter layer is provided between each pixel electrode and a gate insulating film of the array substrate. The first color filter layer of each pixel has spectral characteristics corresponding to the second color filter layer that is provided in association with the reflective region of the pixel. Each reflective region is a region where image display is enabled by light that passes through the corresponding second color filter layer and is reflected by its reflection layer. Each transmittance region is a region where image display is enabled by light that is emitted from a backlight and passes through the corresponding first color filter layer. Spectral separation by the first color filter layers and the second color filter layers enables the liquid crystal element to display an image.

### INCORPORATION BY REFERENCE

The present application claims priority under 35 U.S.C. §119 to Japanese Patent Application No. 2005-119717 filed on Apr. 18, 2005. The content of the application is incorporated herein by reference in its entirety.

### FIELD OF THE INVENTION

The present invention relates to a liquid crystal device having a liquid crystal layer disposed between an array substrate and a counter substrate. The invention further relates to a method of producing such a liquid crystal device.

### BACKGROUND OF THE INVENTION

A conventional liquid crystal device of this type is widely used as a display of a laptop computer, a portable personal computer, or a word processor, because it not only can be made light and thin, but also operates with a low driving voltage as well as low power consumption, and also has features not apparent in a light emission type image display. There has been a noticeable trend, particularly recently, for active matrix type liquid crystal devices to overtake color CRT for use as a display device.

An example of conventional active matrix liquid crystal devices of this type is disclosed in Japanese Laid-Open Patent Publication No. 2001-296559. The liquid crystal device disclosed therein includes thin film transistors (TFTs) that are formed on a transparent insulating substrate and serve as switching elements. An interlayer insulating film is provided above the transparent insulating substrate, which is provided with the thin film transistors. Pixel electrodes are provided on the interlayer insulating film. Each pixel electrode is electrically connected to a drain electrode of the interlayer insulating film via a contact hole. Thus arranged, these components form an active matrix substrate. A counter substrate is provided opposite the active matrix substrate, and liquid crystal composition is sealed between the active matrix substrate and the counter substrate and thus constitutes a liquid crystal layer.

However, because the liquid crystal device described above is a nonemissive display device, it reduces visibility of displayed images in a bright environment, such as outdoors.

In order to solve the above problem, an object of the invention is to provide a liquid crystal device with superior visibility as well as a method of producing such a liquid crystal device.

### SUMMARY OF THE INVENTION

The present invention relates to a liquid crystal device that has an array substrate, a counter substrate arranged in counterposition to the array substrate, and a liquid crystal layer provided between the array substrate and the counter substrate. The array substrate includes a first substrate, a plurality of signal lines and scanning lines provided on one principal surface of the first substrate, a plurality of pixels, switching elements, first insulating layers, and pixel electrodes. The signal lines and the scanning lines are arranged so that the signal lines intersect with the scanning lines to form regions that respectively contain the aforementioned pixels, each of which has a predetermined aperture area. The switching elements are provided in association with the respective pixels. The first insulating layers are provided on the aforementioned principal surface of the first substrate so as to cover the first substrate as well as the switching elements. The pixel electrodes are respectively provided on the first insulating layers of the pixels and electrically connected to the switching elements. The counter substrate includes a second substrate and second insulating layers provided on one principal surface of the second substrate. Each first insulating layer of the array substrate has spectral characteristics for one of at least three colors that comprise a first color, a second color, and a third color respectively corresponding to light's three primary colors. Each second insulating layer of the counter substrate faces at least a part of each respective pixel electrode of the array substrate and has spectral characteristics corresponding to those of each respective first insulating layer.

The aforementioned array substrate is produced by forming first insulating layers having predetermined spectral characteristics on one principal surface of the first substrate so as to cover the first substrate as well as the switching elements of the pixels provided on the aforementioned principal surface of the first substrate, and subsequently providing each pixel with a pixel electrode on the first insulating layer of each pixel and electrically connecting each pixel electrode to the corresponding switching element. The counter substrate is formed by providing on the second substrate second insulating layers having spectral characteristics corresponding to those of the respective first insulating layers at such a location that each second insulating layer faces at least a part of each respective pixel electrode of the array substrate. Thereafter, the array substrate and the counter substrate are arranged in counterposition to each other, and a liquid crystal layer is then formed between the array substrate and the counter substrate.

With the configuration as above, as a result of providing the first insulating layers, each of which has spectral characteristics for one of at least three colors that comprise a first color, a second color, and a third color respectively corresponding to light's three primary colors, between the pixel electrodes and the first substrate of the array substrate, the portion of each pixel electrode of the array substrate that does not face the corresponding second insulating layer of the counter substrate serves as a region where image display is enabled by transmittance of light through to the corresponding first insulating layer, and the portion of each pixel electrode of the array substrate that faces the corresponding second insulating layer of the counter substrate serves as a region where image display is enabled by transmittance of light through to the second insulating layer. Therefore, as spectral separation by the first insulating layers or the second insulating layers enables the liquid crystal device to display an image, the visibility of the liquid crystal device is improved.

### BRIEF DESCRIPTION OF THE DRAWINGS

FIG. 1 is an explanatory sectional view of a liquid crystal device according to an embodiment of the present invention.

### DETAILED DESCRIPTION OF THE PREFERRED EMBODIMENT

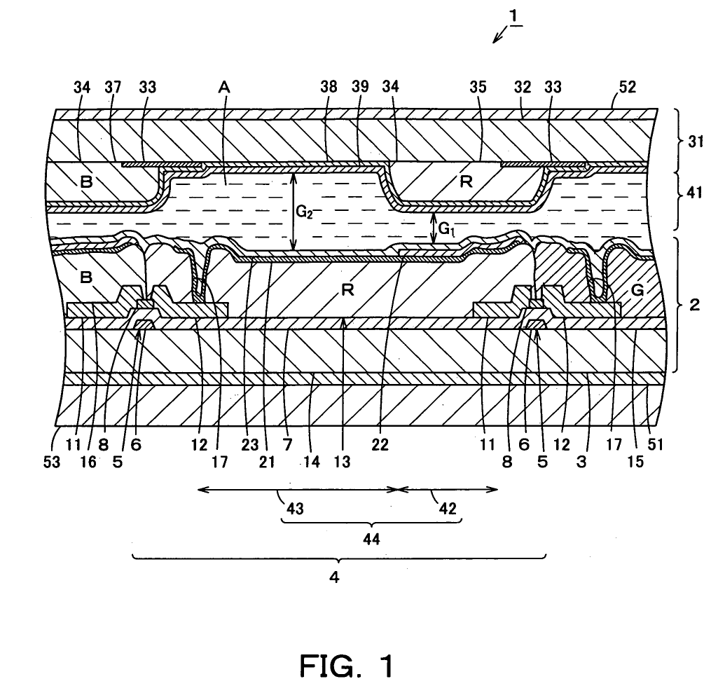

Next, the structure of a liquid crystal device according to an embodiment of the present invention is explained in detail, referring to FIG. 1. In the explanation hereunder, the term “the lateral direction” refers to the lateral direction as viewed in FIG. 1, and the terms “right” and “left”, are as viewed in FIG. 1. The term “the longitudinal direction” refers to the direction perpendicular to the lateral direction as seen from the top view.

In FIG. 1, numeral 1 denotes a liquid crystal element otherwise referred to as a liquid crystal device. The liquid crystal element 1 is a nonemissive display device of a multigap type. The liquid crystal element 1 is an active matrix type semi-transmissive liquid crystal panel and has a bottom gate type array substrate 2 in the shape of a generally rectangular flat plate. The array substrate 2 has a glass substrate 3, which may otherwise be referred to as a first substrate. The glass substrate 3 is a nearly transparent insulating plate formed of a generally rectangular flat translucent plate. An undercoat layer (not shown) is formed on one of the two principal surfaces, i.e. the obverse surface of the glass substrate 3.

A plurality of pixels 4 are arranged in a matrix on the undercoat layer. Each pixel 4 is provided with a bottom gate type thin film transistor (TFT) 5, which serves as a switching element. Each thin film transistor 5 is an active matrix element as well as a TFT element, and is provided with a linear gate electrode 6, which is a gate line serving as a scanning line. The gate electrodes 6 are formed of, for example, aluminum (Al) and are formed as film provided on the undercoat layer. The gate electrodes 6 are parallely arranged at regular intervals with respect to the lateral direction of the glass substrate 3.

A gate insulating film 7 is provided on the undercoat layer so as to cover the entire top surface of the undercoat layer as well as the aforementioned gate electrodes 6 disposed on the gate insulating film 7. The gate insulating film 7 is an insulating layer with electrical insulation properties and formed of, for example, silicon dioxide (SiO₂) or silicon nitride (Si₃N₄) . Semiconductor layers 8, which are formed of, for example, amorphous silicon (a-Si) and serve as an active layer, are provided on the gate insulating film 7, under which the gate electrodes 6 are provided. Each semiconductor layer 8 is provided like an island above each respective gate electrode 6, with the gate insulating film 7 therebetween, and has a width slightly greater than that of the gate electrode 6.

Each semiconductor layer 8 is provided with a source electrode 11 and a drain electrode 12, which collectively serve as a signal line and are electrically insulated from each other. In the case of the present embodiment, the source electrodes 11 and the drain electrodes 12 are formed of chromium (Cr). The source electrodes 11 are parallely arranged at regular intervals with respect to the longitudinal direction of the glass substrate 3. In other words, the source electrodes 11 are arranged perpendicular to the gate electrodes 6 so that each one of the rectangular regions partitioned by the source electrodes 11 and the gate electrodes 16 contains each one of the aforementioned pixels 4.

In the case of the present embodiment, the liquid crystal element 1 is laterally long. The right side (the side corresponding to one of the long-side ends of the liquid crystal element 1) of each source electrode 11 is on the corresponding semiconductor layer 8, and the remaining portion, i.e. the portion that is not located on the semiconductor layer 8, is placed on the gate insulating film 7. The left side (the side corresponding to the other long-side end of the liquid crystal element 1) of each drain electrode 12 opposing the source electrode 11 is on the corresponding semiconductor layer 8 and electrically insulated from the right side of the source electrode 11. The remaining portion, i.e. the portion that is not located on the semiconductor layer 8, is placed on the gate insulating film 7 on the opposite side of the semiconductor layer 8 from the source electrode 11.

The entire surface of the gate insulating film 7, which is thus provided with the semiconductor layers 8, the source electrodes 11, and the drain electrodes 12, is covered with first color filter layers 13, which are otherwise referred to as first insulating layers. The first color filter layers 13 are formed of a photosensitive organic resin that can be dyed, as a photosensitive organic resin is easy to be patterned by photo-etching through a photomask (not shown). The first color filter layers 13 are photo-absorption type colored layers with pigments dispersed therein.

The first color filter layers 13 correspond to a set of color units that at least include light's three primary colors, i.e. red, green, and blue. To be more specific, in the case of the present embodiment, the first color filter layers 13 consist of three kinds of dots that comprise first red portions 14, first green portion 15, and first blue portion 16. The first red portions 14 are color layers with spectral characteristics and spectral transmittance for red. The first green portions 15 are color layers with spectral characteristics and spectral transmittance for green, while the first blue portions 16 are color layers with spectral characteristics and spectral transmittance for blue. These dots respectively correspond to the pixels 4 on the array substrate 2 and are arranged in a repetitive pattern along the lateral and longitudinal directions of the glass substrate 3 of the array substrate 2. Each of these first red portions 14, first green portions 15, and first blue portions 16 is formed in a rectangular shape when viewed from the top, with nearly the same dimensions as those of each pixel 4 on the array substrate 2. Furthermore, while these first red portions 14, first green portions 15, and first blue portions 16 have the same thickness, they transmit different wavelengths of light, depending on their colors.

The first color layers 13, which are thus comprised of one of the first red portion 14, the first green portions 15, and the first blue portions 16, are respectively provided with apertures, i.e. contact holes 17. Each contact hole 17 is formed through each respective first color filter layer 13 to the drain electrode 12 of the thin film transistor 5 so as to serves as a conducting portion. To be more specific, each contact hole 17 is a through hole located separated from the semiconductor layer 8 of each thin film transistor 5 and passes through to the drain electrode 12 of the thin film transistor 5.

A transparent pixel electrode 21 formed of indium tin oxide (ITO) is provided on each first color filter layer 13 and electrically connected to the drain electrode of the thin film transistor 5, via the contact hole 17 of the first color filter layer 13, so that activation of each pixel electrode 21 is controlled by the corresponding thin film transistor 5. The pixel electrodes 21 respectively correspond to the pixels 4, and the aforementioned first color filter layers 13 are respectively located underneath these pixel electrodes 21. To be more specific, each pixel electrode 21 is provided as an integral, continuous body that extends from a point at a given distance from the inner portion (the portion closer to the semiconductor layer 8) of the drain electrode 12 of the thin film transistor 5 in a pixel 4 to a point at a given distance from the inner portion (the end closer to the semiconductor layer 8) of the source electrode 11 of the thin film transistor 5 on the drain electrode-side of the first mentioned thin film transistor 5.

A reflection layer 22 for reflecting the light from the obverse surface of the glass substrate 3 is provided on each pixel electrode 22. Each reflection layer 22 is provided as an integral, continuous body that extends in the lateral direction from an approximate midway point of the corresponding pixel electrode 21 to the right edge of the pixel electrode 21, i.e. the end above the left side of the thin film transistor 5 on the drain electrode-side of the thin film transistor 5 that serves to drive the pixel electrode 21. Each reflection layer 22 has such reflection characteristics as to reflect rays of light coming from above as well as rays of light coming from below. The reflection layer 22 has a double-layered structure that comprises a molybdenum (Mo) layer and an aluminum (Al) layer and has surface reflectance of 90% or more for light with a wavelength in the range of 400 nm to 700 nm, in other words visible light from red light to violet light. Furthermore, an alignment film 23 formed by alignment processing of polyimide is provided on the entire top surface of the first color filter layers 13 so as to cover the first color filter layers 13 as well as the reflection layers 22 and the pixel electrodes 21 provided thereon.

A counter substrate 31 that has a shape of a flat rectangular plate and serves as a common substrate is provided opposite the array substrate 2. The counter substrate 31 has a glass substrate 32, which is otherwise referred to as a second substrate. The glass substrate 32 is a nearly transparent insulating plate formed of a generally rectangular flat translucent plate. Light-shield layers 33 are formed on one of the two principal surfaces of the glass substrate 3, i.e. the surface facing the array substrate 2, so that the light-shield layers 33 respectively correspond to the pixels 4 of the array substrate 2 when the glass substrate 32 is positioned to face the glass substrate 3 of the array substrate 2. The light-shield layers 33 are provided so that, when the glass substrate 32 of the counter substrate 31 faces the glass substrate 3 of the array substrate 2, the light-shield layers 33 respectively cover specific portions of the first color filter layers 13 of the pixels on the glass substrate 3. The aforementioned specific portions are the portions that are not covered by the pixel electrodes 21. In other words, each light-shield layer 33 is provided as an integral, continuous body that extends in the lateral direction from an approximate midway point of the source electrode 11 of each thin film transistor 5 of the array substrate 2 to an approximate midway point of the drain electrode 12 of the thin film transistor 5.

Second color filter layers 34, which may otherwise be referred to as second insulating layers, are formed on the glass substrate 32 of the counter substrate 31 so that the second color filter layers 34 respectively face towards the reflection layers 22 of the pixels 4 of the array substrate 2 when the glass substrate 32 faces the glass substrate 3 of the array substrate 2. Each second color filter layer 34 is provided at such a location as to be vertically aligned with and face the reflection layer 22 of each respective pixel 4 of the array substrate 2 when the counter substrate 31 faces the array substrate 2. In other words, each second color filter layer 34 is provided at such a location as to overlap the reflection layer 22 of each respective pixel 4 when the liquid crystal element 1 is viewed from the vertical direction, i.e. from the normal line of the glass substrate 3.

In the same manner as the first color filter layers 13, the second color filter layers 13 correspond to a set of color units that at least include light's three primary colors, i.e. red, green, and blue. To be more specific, in the case of the present embodiment, the second color filter layers 34 consist of three kinds of dots that comprise second red portions 35, second green portion (not shown), and second blue portion 37. The second red portions 35 are color layers with spectral characteristics and spectral transmittance for red. The second green portions are color layers with spectral characteristics and spectral transmittance for green, while the second blue portions 37 are color layers with spectral characteristics and spectral transmittance for blue. These dots, which respectively correspond to the red portions 14, the green portions 15, and the blue portions 16 of the first color filter layer 13 of the pixels 4 on the array substrate 2, are arranged in a repetitive pattern along the lateral and longitudinal directions of the glass substrate 3 of the array substrate 2.

These second red portions 35, second green portions (not shown), and second blue portions 37 are arranged so that when the glass substrate 32 of the counter substrate 31 faces the glass substrate 3 of the array substrate 2, each of these second color portions faces at least a part of each respective pixel electrode 21 of the array substrate 2 and a first red portion 14, a first green portion 15, or a first blue portion 16 in a pixel 4 on the array substrate 2. To be more specific, each red portion 35 extends in the lateral direction from a point above the left edge of the opposing reflection layer 22, in other words a point above an approximate midway point of the corresponding first red portion 14, to a point above the right edge of the reflection layer 22, in other words the right edge of the first red portion 14, so as to cover the reflection layer 22. Each second green portion extends in the lateral direction from a point above the left edge of the opposing reflection layer 22, in other words a point above an approximate midway point of the corresponding first green portion 15, to a point above the right edge of the reflection layer 22, in other words the right edge of the first green portion 15, so as to cover the reflection layer 22. Each second blue portion 37 extends in the lateral direction from a point above the left edge of the opposing reflection layer 22, in other words a point above an approximate midway point of the corresponding first blue portion 16, to a point above the right edge of the reflection layer 22, in other words the right edge of the first blue portion 16, so as to cover the reflection layer 22.

Each one of these second red portions 35, second green portions 36, and second blue portions 37 covers the left side of each respective light-shield layer 33 on the glass substrate 32 of the counter substrate 31, i.e. the part from the midportion to the left edge of the light-shield layer 33. The aforementioned left side of the light-shield layer 33 is located above the source electrode 11 of the thin film transistor 5 that faces towards the light-shield layer 33. In other words, the right side portion of each second red portion 35, second green portion 36, or second blue portion 37 overlaps approximately half of the of each respective light-shield layer 33. Furthermore, while these second red portions 35, second green portions, and second blue portions 37 have the same thickness, they transmit different wavelengths of light, depending on their colors.

The entire surface of the glass substrate 32, as well as the second red portions 35, the second green portions, the second blue portions 37, and the light-shield layers 33 provided thereon, is covered by a counter electrode 38, which is a common electrode formed of ITO. Furthermore, an alignment film 39 formed by alignment processing of polyimide is provided on the counter electrode 38.

The alignment film 39 of the counter substrate 31 and the alignment film 23 of the array substrate 2 are arranged to be spaced apart and face each other by means of spacers that are substrate spacer materials not shown in the drawing provided between the two alignment films, so as to form a liquid crystal sealing region A. The width of the liquid crystal sealing region A, which is the gap between the alignment film 39 of the counter substrate 31 and the alignment film 23 of the array substrate 2, comprises cell gaps G₁,G₂. The liquid crystal sealing region A is filled with a liquid crystal composition (not shown) and sealed so as to form a liquid crystal layer 41, which serves as an optical modulation layer.

Of each pixel of the array substrate 2, the region that is covered with its reflection layer 22 but not the light-shield layer 33 serves as a reflective region 42 where the reflection method is employed, in other words a light reflecting region where image display is enabled by reflection of light. Therefore, each reflective region 42 is a region extending from one side, i.e. the left edge, of the reflection layer 22 of each pixel 4 to the left edge of the light-shield layer 33 on which the second color filter layer 34 provided on the reflection layer 22 is provided.

Furthermore, the region of each pixel 4 that is covered with neither the reflection layer 22 nor the light-shield layer 33 serves as a transmittance region 43 where the transmittance method is employed, in other words a light transmittance region where image display is enabled by transmittance of light. Therefore, each transmittance region 43 is a region extending from the right edge of the light-shield layer 33 above the thin film transistor 5 of each pixel 4 to the left edge of the reflection layer 22 within the boundary of the pixel 4.

Each pixel 4 of the array substrate 2 is provided within its boundary with one each reflective region 42 and transmittance region 43 described above so that the reflective region 42 and the transmittance region 43 in each pixel 4 together form a color reproduction region 44 that enables reproduction of a predetermined color in the pixel 4. Therefore, each pixel 4 has an aperture with a given area that is equal to the aperture area of its color reproduction region 44 when seen from the top view, the aforementioned aperture area being the sum of the aperture area of the reflective region 42 and the aperture area of the transmittance region 43. The reflective region 42 in each pixel 4 is formed so that the area of the reflection layer 22 occupied by the reflective region 42 does not exceed 50% of the area of the aperture of the pixel electrode 21 of the pixel 4 and that the area of the portion of the second color filter layer 34 occupied by the reflective region 42 when seen from the top view does not exceed 50% of the aperture area of the pixel 4.

Furthermore, each reflective region 42 comprises the aforementioned cell gap G₁, which corresponds to the distance from the portion of the alignment layer 23 overlapping the reflection layer 22 of the array substrate 2 to the alignment layer 39 on the second color filter layer 34 of the counter substrate 31. Each transmittance region 43 comprises the aforementioned cell gap G₂, which corresponds to the distance from the portion of the alignment layer 23 overlapping the portion of the pixel electrode 21 of the array substrate 2 that is not covered by the reflection layer 22 to the portion of the alignment layer 39 overlapping the portion of the counter electrode 38 of the counter substrate 31 that is covered by neither the light-shield layer 33 nor the second color filter layer 34. Therefore, the cell gap G₂ is greater than the cell gap G₁ by the approximate thickness of the reflection layer 22 and the second color filter layer 34. To be more specific, in the case of the present embodiment, the cell gap G₂ is approximately twice as long as the cell gap G₁.

A polarizer 51, 52 in the shape of a flat rectangular plate is provided and bonded to the other principal surface, i.e. the reverse surface, of each glass substrate 3, 32 of the array substrate 2 or the counter substrate 31. Furthermore, a backlight 53, which is a surface light source in the shape of a flat rectangular plate, is disposed behind the array substrate 2 so as to face the reverse surface of the polarizer 51, which is bonded to the glass substrate 3 of the array substrate 2. The backlight 53 serves to cause surface light to enter the reverse side of the array substrate 2 so that colors displayed on the transmittance regions 43 in the pixels 4 of the array substrate 2 can be made visible by controlling the pixel electrodes 21 by means of the thin film transistors 5 on the array substrate 2.

Therefore, by switching the thin film transistors 5 of the appropriate pixels 4 to apply visual signals to their pixel electrodes 21 and thereby controlling the alignment of the liquid crystal composition in the liquid crystal layer 41, the liquid crystal element 1 modulates the light that passes through the first color filter layers 13 in the corresponding transmittance region and the light that passes through the second color filter layers 34 in the corresponding reflection regions and is reflected by the reflection layers 22 so as to make a given image visible.

Next, the method of producing a liquid crystal element according to the embodiment described above is explained hereunder.

First, an undercoat layer is formed on the glass substrate 2, and an aluminum film with a thickness of approximately 0.3 μm is formed on the undercoat layer by sputtering and is patterned into a predetermined shape by photolithography to form the gate electrodes 6.

Next, after a gate insulating film 7 of silicon dioxide or silicon nitride with a thickness of approximately 0.15 μm is formed on the undercoat layer so as to cover the undercoat layer as well as the gate electrodes 6 formed thereon, semiconductor layers 8 are formed of amorphous silicon on the gate insulating film 7 at locations respectively corresponding to those of the gate electrodes 6.

Then, chromium films with a thickness of approximately 0.3 μm are formed on either side of each semiconductor layers 8 to form the source electrode 11 and the drain electrode 12. Thus, thin film transistors 5 are formed.

Thereafter, a composition prepared by dispersing organic red pigment in an amount of approximately 20% by mass in a photo-setting acrylic type, alkali-developable resist solution is applied with a spinner (not shown) to the surface of the gate insulating film 7 so as to cover the gate insulating film 7 as well as the thin film transistors 5 formed thereon, and prebaking, i.e. initial baking, is then performed for 5 minutes at 90° C. Thereafter, the glass substrate 3 is exposed to, for example, 150 mJ/cm² of ultraviolet light through a photomask (not shown).

The exposed glass substrate 3 is developed for 60 seconds in aqueous solution of Tetra Methyl Ammonium Hydroxide (TMAH) with a mixing ratio of 0.1% by mass and then washed with water. Thereafter, the glass substrate 3 undergoes post-baking, i.e. final baking, for one hour at 200° C. so as to form the first red portions 14 with a thickness of approximately 4 μm on the apertures of the respective pixels 4.

Thereafter, first green portion 15 and, subsequently, first blue portion 16 are formed, by employing the same method used for the first red portions 14, on the gate insulating film 7 so as to cover the gate insulating film 7 as well as the thin film transistors 5 formed thereon. Thus, the first color filter layers 13 are formed.

Thereafter, contact holes 17 are respectively formed in the first red portions 14, the first green portion 15, and the first blue portion 16 of the first color filter layers 13 to expose the drain electrodes 12 of the thin film transistors 5.

ITO is deposited to a thickness of approximately 0.1 μm on these first red portions 14, first green portions 15, and first blue portions 16, including the contact holes 17 with the exception of the portions above the semiconductor layers 8 of the thin film transistors 5, to form the pixel electrodes 21 and electrically connect these pixel electrodes 21 to the drain electrodes 12 of the respective thin film transistors 5.

Thereafter, a two-layer structure consisting of a molybdenum layer and an aluminum layer is formed on a part of each pixel electrode 21 and subsequently patterned, so as to form a reflection layer 22 having an area that is approximately 40% of the area of the pixel electrode 21.

Next, the alignment layer 23 is formed on the entire surface of the first color filter layers 13 so as to cover the first color filter layers 13 as well as their reflection layers 22 and pixel electrodes 21. Thus the array substrate 2 is formed.

The light-shield layers 33 are provided by forming a chromium film on the glass substrate 32 and patterning the chromium film by photolithography so that the chromium film covers the glass substrate 32 with the exception of the portions corresponding to the apertures of the pixels 4.

Thereafter, the second color filter layers 34 are provided by forming the second red portions 35, the second green portions, and the second blue portions 37 on the glass substrate 32 by means of photolithography so as to cover parts of the glass substrate as well as its light-shield layers 33. To be more specific, the second red portions 35, the second green portions, and the second blue portions 37 are formed at such locations that when the glass substrate 32 is positioned to face the glass substrate 3 of the array substrate 2, each of these second color portions faces each respective first red portion 14, first green portion 15, or first blue portion 16 on the array substrate 2.

Then, the counter electrode 38 is provided by forming a film of ITO so as to cover the entire surface of the glass substrate 32 as well as its light-shield layers 33 and second color filter layers 34, which are comprised of the second red portions 35, the second green portions, and the second blue portions 37, and the alignment layer 39 is subsequently formed on the counter electrode 38. Thus the counter substrate 31 is formed.

Thereafter, the counter substrate 31 and the array substrate 2 are arranged so that the alignment layer 39 of the counter substrate 31 and the alignment layer 23 of the array substrate 2 face each other with the spacers disposed therebetween and that the liquid crystal sealing region A is formed between the two alignment layers 23, 39.

Then, the aforementioned liquid crystal composition is filled and sealed in the liquid crystal sealing region A between the alignment layer 39 of the counter substrate 31 and the alignment layer 23 of the array substrate 2 so as to form the liquid crystal layer 41.

The polarizers 51, 52 are respectively bonded to the backside of the glass substrate 3 of the array substrate 2 and the backside of the glass substrate 32 of the counter substrate 31, and, thereafter, the backlight 53 is disposed so as to face the backside of the polarizer 51 of the array substrate 2 and attached thereto. Thus, the liquid crystal element 1 is formed.

Of each pixels of the liquid crystal element 1, the region that is covered with its reflection layer 22 but not the light-shield layer 33 serves as the reflective region 42, while the region of each pixel 4 that is covered with neither the reflection layer 22 nor the light-shield layer 33 serves as the transmittance region 43. Furthermore, the reflective region 42 and the transmittance region 43 in each pixel 4 together form a color reproduction region 44.

As described above, according to the present embodiment, the first color filter layers 13 are provided between the gate insulating film 7 and the pixel electrodes 21 of the array substrate 2 of the liquid crystal element 1, of which each pixel 4 is provided with a reflective region 42 and a transmittance region 43, and each first color filter layer 13 has spectral characteristics corresponding to those of the second color filter layer 34 provided in the reflective region 42 of the pixel 4 associated with the aforementioned first color filter layer 13.

Therefore, each reflective region 42 of the liquid crystal element 1 serves as a region where image display is enabled by light that passes through the corresponding second color filter layer 34 of the counter substrate 31 and is reflected by the reflection layer 22. Furthermore, the cell gap G₁ of each reflective region 42 corresponds to the distance from the portion of the alignment layer 23 overlapping the reflection layer 22 of the array substrate 2 to the alignment layer 39 on the second color filter layer 34 of the counter substrate 31.

Each transmittance region 43 of the liquid crystal element 1 serves as a region where image display is enabled by light that is emitted from the backlight 53 and passes through the corresponding first color filter layer 13 of the array substrate 2. Furthermore, the cell gap G₂ of each transmittance region 43 corresponds to the distance from the portion of the alignment layer 23 overlapping the portion of the pixel electrode 21 of the array substrate 2 that is not covered by the reflection layer 22 to the portion of the alignment layer 39 overlapping the portion of the counter electrode 38 of the counter substrate 31 that is covered by neither the light-shield layer 33 nor the second color filter layer 34.

With the configuration as above, wherein spectral separation by the first color filter layers 13 and the second color filter layers 34 enables the liquid crystal element 1 to display an image, the visibility of the liquid crystal element 1 is improved.

As the spectral transmittance of the first color filter layers 13, as well as the cell gap G₁ of the reflective regions 42 and the cell gap G₂ of the transmittance region 43, can be optimized by adjusting the thickness of the first color filter layers 13, the optical path difference between the cell gap G₁ of the reflective regions 42 and the cell gap G₂ of the transmittance regions 43 can be changed. Therefore, the configuration as above enables the reflective regions 42 and the transmittance regions 43 to be provided with multiple gaps without the necessity of further layers and also eliminates the necessity of another layer to ensure insulation between the pixel electrodes 21 and the thin film transistors 5.

Furthermore, the area of the color reproduction regions 44, each of which is comprised of one each reflective regions 42 and transmittance regions 43, can be increased by adjusting the thickness of the first color filter layer 13, resulting in the liquid crystal element 1 with visibility substantially superior to conventional liquid crystal elements indoors, outdoors, or in any condition. Therefore, by thus enabling the increase of the reliability and yield of the liquid crystal element having such a superior visibility, the present invention enables the production of the liquid crystal element having superior visibility at lower production costs.

According to the embodiment described above, each reflection layer 22 occupies approximately 40% of the area of the aperture of each respective pixel 4 of the liquid crystal element 1. Should the area of each reflection layer 22 be not more than 5% of the area of the aperture of each respective pixel 4, the visibility of the liquid crystal element 1 is impaired in an environment directly exposed to sunlight, such as outdoors. On the other hand, the reflection layers 22 greater than the 50% of the area of the apertures of the pixels 4 reduces the area of the transmittance regions 43 as well as the aperture area of the pixels 4; in other words, reduces the aperture ratio, resulting in impaired visibility in a dark environment. Another drawback of such wide reflection layers 22 lies in that in cases where the liquid crystal element 1 is used as a transmission type liquid crystal element 1 where transmission of light from the backlight 53 ensures visibility even in a dark environment, such as nighttime, the backlight 53 requires greater power. It is desirable that the area of each reflection layer 22 be in the range of 5% to 50% of the area of the aperture of each respective pixel 4.

As each reflection layer 22 of the array substrate 2 is provided at such a location as to overlap each respective second color filter layer 34 of the counter substrate 31, the area of the transmittance region 43 in each pixel 4 of the array substrate 2 is reduced so that a sufficient aperture ratio of the pixels 4, in which the transmittance regions 43 are respectively provided, can be ensured. As the second color filter layers 34 are formed of a material that can be dyed, the second color filter layers 34 according to the invention can be produced by such means as dyeing with pigments. Therefore, the present invention not only improves manufacturability of the first color filter layers 13 but also enables more reliable and efficient spectral.

According to the embodiment described above, the first color filter layers 13 are comprised of the first red portions 14 with spectral characteristics for red, the first green portions 15 with spectral characteristics for green, and the first blue portions 16 with spectral characteristics for blue. However, the colors of the first red portions 14, the first green portions 15, or the first blue portions 16 may be a red that is close to orange, a green that is close to yellow, or a blue that is close to purple, respectively.

The first color filter layers 13 may be comprised of color layers of at least three colors other than those of the first red portions 14, the first green portions 15, or the first blue portions 16, such as the three primary colors of cyan, magenta, and yellow, or a combination of at least three other colors that correspond to light's three primary colors.

Similarly, the second color filter layers 34, too, may be comprised of color layers of at least three colors that correspond to light's three primary colors other than those of the second red portions 35 with spectral characteristics for red, the second green portions with spectral characteristics for green, or the second blue portions 37 with spectral characteristics for blue.

Furthermore, according to the embodiment described above, the semiconductor layers 8 are formed of amorphous silicon. However, the semiconductor layers 8 may be formed of polysilicon produced by laser annealing of amorphous silicon, amorphous silicon modified by solid-phase growth or rapid thermal annealing (RTA), which calls for the surface of amorphous silicon to be exposed to lamp light and heated to melt, or any other suitable method, or amorphous silicon directly formed by such methods as chemical vapor deposition (CVD) or physical vapor deposition (PVD), provided that the semiconductor layers 8 have predetermined characteristics.

Although the pixel electrode 21 in each pixel 4 is controlled by the corresponding thin film transistor 5 according to the embodiment described above, the switching elements are not limited to thin film transistors 5. Examples of other materials for the switching elements include, but are not limited to, thin film diode (TFD). Furthermore, in addition to the active matrix type liquid crystal element 1 described above, the present invention is applicable to a liquid crystal element of a simple matrix type. According to the embodiment described above, the semiconductor layers 8 of the thin film transistors 5 are formed of amorphous silicon. However, in cases where polysilicon is used to form the semiconductor layers 8, the driving circuit can be incorporated in the liquid crystal element by mounting the driving circuit on the array substrate 2.

Although the first color filter layers 13 on the array substrate 2 are formed of a photosensitive organic resin according to the embodiment described above, the first color filter layers 13 may be formed of non-photosensitive insulating layers. Furthermore, although the first color filter layers 13 according to the present embodiment are colored layers with pigments dispersed therein, the first color filter layers 13 may be colored with dyes or by other appropriate means, provided that desired spectral characteristics are ensured. Moreover, although the first color filter layers 13 according to the present embodiment are photo-absorption type colored layers with pigments dispersed therein, the first color filter layers 13 may be colored layers of a non-photo-absorption type, such as an optical interference type for interfering rays of light having specified wavelengths or a selective reflection for selectively reflecting light, or any other appropriate type, provided that desired spectral characteristics are ensured.

According to the embodiment described above, a photosensitive resin having a pigment dispersion equal to that of the first color filter layer 13 is used to form the second color filter layers 34 that respectively correspond to the first color filter layers 13. However, depending on the cell gaps G₁,G₂ of the reflective regions 42 and transmittance regions 43 of the liquid crystal element 1, the pigment dispersion of the first color filter layers 13 or the second color filter layers 34 may be changed so as to ensure that the colors displayed by the reflective regions 42 are identical to the colors displayed by the transmittance regions 43.

What is claimed is:

1. A liquid crystal device comprising:
an array substrate that includes:
a first substrate,
a plurality of signal lines and scanning lines so provided on one principal surface of said first substrate that the signal lines intersect with the scanning lines,
a plurality of pixels respectively contained in regions partitioned by said signal lines and scanning lines, each pixel having a predetermined aperture area,
switching elements respectively provided in association with said pixels,
first insulating layers provided on said principal surface of said first substrate so as to cover said first substrate as well as said switching elements, and
pixel electrodes respectively provided on the first insulating layers of said pixels and electrically connected to said switching elements;
a counter substrate that is arranged in counterposition to said array substrate and includes a second substrate, and second insulating layers provided on one principal surface of said second substrate; and
a liquid crystal layer provided between said array substrate and said counter substrate, wherein:
each first insulating layer of said array substrate has spectral characteristics for one of at least three colors comprising a first color, a second color, and a third color respectively corresponding to light's three primary colors; and
each second insulating layer of said counter substrate faces at least a part of each respective pixel electrode of said array substrate and has spectral characteristics corresponding to those of each respective first insulating layer.

2. A liquid crystal device as claimed in claim 1, wherein:
said first color is red;
said second color is green; and
said third color is blue.

3. A liquid crystal device as claimed in claim 1, wherein:
said array substrate includes reflection layers, each of which is provided on at least a part of each one of said first insulating layers and has an area not exceeding 50% of said aperture area of each pixel.

4. A liquid crystal device as claimed in claim 1, wherein:
each second insulating layer of said counter substrate has an area not exceeding 50% of said aperture area of each pixel.

5. A liquid crystal device as claimed in claim 3, wherein:
said array substrate includes reflection layers, each of which is provided at such a location as to occupy at least a part of each one of said first insulating layers and overlap each respective second insulating layer of said counter substrate.

6. A liquid crystal device as claimed in claim 4, wherein:
said array substrate includes reflection layers, each of which is provided at such a location as to occupy at least a part of each one of said first insulating layers and overlap each respective second insulating layer of said counter substrate.

7. A liquid crystal device as claimed in claim 3, wherein:
each reflection layer has surface reflectance of 90% or more for light with a wavelength in the range of 400 nm to 700 nm.

8. A liquid crystal device as claimed in claim 4, wherein:
each reflection layer has surface reflectance of 90% or more for light with a wavelength in the range of 400 nm to 700 nm.

9. A liquid crystal device as claimed in claim 1, wherein:
said first insulating layers are formed of a photosensitive resin.

10. A liquid crystal device as claimed in claim 5, wherein:
said second insulating layers are provided at such a location as to overlap said reflection layers when viewed from the normal line of said first substrate.

11. A liquid crystal device as claimed in claim 1, wherein:
said first insulating layers and second insulating layers are photo-absorption type color filter layers with pigments dispersed therein.

12. A liquid crystal device as claimed in claim 1, wherein:
each one of said second insulating layers extends in the lateral direction from a point corresponding to an approximate midway point of each respective first insulating layer to a point corresponding to one of the lateral ends of said first insulating layer.

13. A liquid crystal device as claimed in claim 1, wherein:
said array substrate includes light-shield layers, each of which is provided between one of each respective pixel and its adjacent pixel; and
each second insulating layer overlaps at least a part of each respective light-shield layer.

14. A liquid crystal device as claimed in claim 3, wherein:
the region covered by each reflection layer is a reflective region where viewability is enabled by using reflection of light; and
the region that each reflection layer does not cover is a transmittance region where viewability is enabled by using transmittance of light.

15. A liquid crystal device as claimed in claim 1, wherein:
said switching elements are thin film transistors.

16. A liquid crystal device as claimed in claim 3, wherein:
each reflection layer has a double-layered structure comprising a molybdenum (Mo) layer and an aluminum (Al) layer.

17. A method of producing a liquid crystal device comprising an array substrate, a counter substrate that is arranged in counterposition to said array substrate, and a liquid crystal layer provided between said array substrate and said counter substrate, wherein said method includes:
a step of forming said array substrate by forming switching elements on a first substrate, forming first insulating layers on said first substrate so as to cover said first substrate as well as said switching elements, each first insulating layer having spectral characteristics for one of at least three colors comprising a first color, a second color, and a third color respectively corresponding to light's three primary colors, and providing pixel electrodes respectively on said first insulating layers, said pixel electrodes electrically connected to said switching elements respectively; and
a step of forming said counter substrate by providing second insulating layers on a second substrate at such a location that each second insulating layer faces at least a part of each respective pixel electrode of said array substrate, each second insulating layer having spectral characteristics corresponding to those of each respective first insulating layer.

18. A method of producing a liquid crystal device as claimed in claim 17, wherein:
said first color, second color, and third color that respectively correspond to light's three primary colors are red, green, and blue; and
the spectral characteristics of each first insulating layer are for one of at least three colors comprising said red, green, and blue.

19. A method of producing a liquid crystal device as claimed in claim 17, wherein:
said step of forming first insulating layers is a step in which first insulating layers are formed of a photosensitive resin.

20. A method of producing a liquid crystal device as claimed in claim 17, wherein:
said step of forming first insulating layers is a step that calls for patterning by photo-etching through a photomask.

21. A method of producing a liquid crystal device as claimed in claim 19, wherein:
said step of forming first insulating layers is a step that calls for sequentially carrying out application of a composition prepared by dispersing organic red pigment in a photo-setting resist solution, initial baking, exposure to light through a photomask, development, water washing, and final baking.

22. A method of producing a liquid crystal device as claimed in claim 17, wherein:
said method calls for forming reflection layers so that each reflection layer is provided on at least a part of each one of said first insulating layers and has an area not exceeding 50% of said aperture area of each pixel.

23. A method of producing a liquid crystal device as claimed in claim 17, wherein:
light-shield layers are formed so that each light-shield layer is provided between one of each respective pixel and its adjacent pixel; and
said step of forming second insulating layers is a step in which second insulating layers are formed so that each second insulating layer overlaps at least a part of each respective light-shield layer.
